(19) United States
(12) Patent Application Publication
(10) Pub. No.: US 2025/0291826 A1
(43) Pub. Date: Sep. 18, 2025

(54) RECALL MODEL TRAINING METHOD, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Jin MA, Shenzhen (CN); Yaning CHANG, Shenzhen (CN)

(21) Appl. No.: 19/224,054

(22) Filed: May 30, 2025

Related U.S. Application Data
(63) Continuation of application No. PCT/CN2024/083436, filed on Mar. 25, 2024.

(30) Foreign Application Priority Data
May 11, 2023 (CN) 202310525095.8

(51) Int. Cl. G06F 16/3329; G06F 40/30

(52) U.S. Cl. CPC G06F 16/33295; G06F 40/30

(57) ABSTRACT

A method for recall model training includes: obtaining first text pairs with a first text pair including a first question text, generated based on description information of multimedia and using a resource identifier of the multimedia as a question target, and a first answer text, being a resource identifier targeted by a question of the first question text; pre-training a recall model; obtaining second text pairs with a second text pair including a second question text that uses a resource identifier of related multimedia as a question target, and a second answer text being a resource identifier of the related multimedia targeted by a question of the second question text, and the related multimedia involved in the second text pair corresponding to the multimedia involved in the first text pair; and performing fine tune training on the pre-trained recall model based on second question texts and second answer texts.

### CROSS-REFERENCES TO RELATED APPLICATIONS

This application is a continuation application of PCT Patent Application No. PCT/CN2024/083436, filed on Mar. 25, 2024, which claims priority to Chinese Patent Application No. 2023105250958, filed on May 11, 2023, all of which is incorporated herein by reference in their entirety.

### FIELD OF THE TECHNOLOGY

The present disclosure relates to the field of artificial intelligence technologies, and more specifically, to recall model training and multimedia recall.

### BACKGROUND OF THE DISCLOSURE

With the development of multimedia technologies, a quantity of multimedia such as audio and video also increases rapidly. Accurately recalling multimedia from a large amount of multimedia can effectively shorten time that takes for user to query multimedia. If the recalled multimedia is not highly relevant to the multimedia that the user actually expects, that is, the accuracy of multimedia recall is not high, the user needs to perform multiple queries and searches, resulting in multiple interactions between the user's terminal and the multimedia server. Therefore, how to improve multimedia recall accuracy is a technical problem that needs to be urgently resolved in the related technologies.

### SUMMARY

One embodiment of the present disclosure provides a method for recall model training, performed by an electronic device. The method includes: obtaining a plurality of first text pairs, a first text pair of the plurality of first text pairs including a first question text and a first answer text, the first question text being a text generated based on description information of multimedia and using a resource identifier of the multimedia as a question target, and the first answer text being a resource identifier targeted by a question of the first question text; pre-training a recall model based on first question texts and first answer texts in the plurality of first text pairs; obtaining a plurality of second text pairs, the second text pair of the plurality of second text pairs comprising a second question text and a second answer text, the second question text being a text that uses a resource identifier of related multimedia as a question target, the second answer text being a resource identifier of the related multimedia targeted by a question of the second question text, and the related multimedia involved in the second text pair corresponding to the multimedia involved in the first text pair; and performing fine tune training on the pre-trained recall model based on second question texts and second answer texts in the plurality of second text pairs.

Another embodiment of the present disclosure provides an electronic device. The electronic device includes one or more processors and a memory containing a computer program that, when being executed, causes the one or more processors to perform: obtaining a plurality of first text pairs, a first text pair of the plurality of first text pairs including a first question text and a first answer text, the first question text being a text generated based on description information of multimedia and using a resource identifier of the multimedia as a question target, and the first answer text being a resource identifier targeted by a question of the first question text; pre-training a recall model based on first question texts and first answer texts in the plurality of first text pairs; obtaining a plurality of second text pairs, the second text pair of the plurality of second text pairs comprising a second question text and a second answer text, the second question text being a text that uses a resource identifier of related multimedia as a question target, the second answer text being a resource identifier of the related multimedia targeted by a question of the second question text, and the related multimedia involved in the second text pair corresponding to the multimedia involved in the first text pair; and performing fine tune training on the pre-trained recall model based on second question texts and second answer texts in the plurality of second text pairs.

Another embodiment of the present disclosure provides a non-transitory computer-readable storage medium containing a computer program that, when being executed, causes at least one processor to perform: obtaining a plurality of first text pairs, a first text pair of the plurality of first text pairs including a first question text and a first answer text, the first question text being a text generated based on description information of multimedia and using a resource identifier of the multimedia as a question target, and the first answer text being a resource identifier targeted by a question of the first question text; pre-training a recall model based on first question texts and first answer texts in the plurality of first text pairs; obtaining a plurality of second text pairs, the second text pair of the plurality of second text pairs comprising a second question text and a second answer text, the second question text being a text that uses a resource identifier of related multimedia as a question target, the second answer text being a resource identifier of the related multimedia targeted by a question of the second question text, and the related multimedia involved in the second text pair corresponding to the multimedia involved in the first text pair; and performing fine tune training on the pre-trained recall model based on second question texts and second answer texts in the plurality of second text pairs.

### BRIEF DESCRIPTION OF THE DRAWINGS

FIG. 1 is a schematic diagram of an application scenario according to an embodiment of the present disclosure.

FIG. 2 is a flowchart of a recall model training method according to an embodiment of the present disclosure.

FIG. 3 is a schematic diagram of training a recall model according to an embodiment of the present disclosure.

FIG. 4 is a schematic diagram of a structure of a recall model according to an embodiment of the present disclosure.

FIG. 5 exemplarily shows a schematic diagram of encoding and decoding processing performed by using a BART model.

FIG. 6 exemplarily shows a schematic diagram of a transformer model.

FIG. 7 is a flowchart of operation 220 in an embodiment according to an embodiment of the present disclosure.

FIG. 8 is a flowchart of operation 240 in an embodiment according to an embodiment of the present disclosure.

FIG. 9 is a flowchart of a recall method according to an embodiment of the present disclosure.

FIG. 10 is a flowchart of a recall method according to another embodiment of the present disclosure.

FIG. 11 is a block diagram of a recall model training apparatus according to an embodiment of the present disclosure.

FIG. 12 is a block diagram of a recall apparatus according to an embodiment of the present disclosure.

FIG. 13 is a schematic diagram of a structure of a computer system adapted for implementing an electronic device according to an embodiment of the present disclosure.

### DESCRIPTION OF EMBODIMENTS

Exemplary implementations will now be described more thoroughly with reference to the accompanying drawings. However, the exemplary implementations may be implemented in various forms, and are not to be understood as being limited to the examples described herein. Instead, the implementations are provided to make the present disclosure more thorough and complete, and fully convey the idea of the exemplary implementations to a person skilled in the art.

“Plurality of” mentioned in the specification means two or more. The “and/or” describes an association relationship for describing associated objects and represents that three relationships may exist. For example, A and/or B may represent the following three cases: Only A exists, both A and B exist, and only B exists. The character “/” generally represents an “or” relationship between the associated objects.

Before the solution of the present disclosure is described in detail, terms of the present disclosure are explained as follows:

Sequence to sequence (Seq2Seq) model: The Seq2Seq model is a neural network model that maps a sequence to a sequence. The Seq2Seq model is originally used to improve a machine translation technology, and is used to map a sentence (a word sequence) in one language to a corresponding sentence in another language.

Text generation: Text generation means generating an understandable text from non-linguistic representation. Based on different divisions of the non-language representation, text generation includes “text→text”, “data→text”, and “image→text”.

Pre-training: Pre-training is using as much training data as possible, and extracting as many common features as possible from the training data, to reduce a burden of a model learning a specific task.

Fine tune training (Fine tune): A principle thereof is modifying, by using a known structure of a model and a known parameter of the model, a parameter of an output layer to be used as an output layer of a current task, and performing fine tuning on parameters of several network layers before the last layer (namely, the output layer). In this way, a powerful generalization capability of a deep neural network can be effectively utilized, a complex model design is omitted, and time consumption of training is reduced.

Prompt learning: A core of prompt learning is to convert, by using a certain template, a problem to be resolved into a form similar to a pre-training task for processing. For example, for a text “I missed the bus today.”, a template “I missed the bus today. I felt so [MASK] [MASK]” may be constructed, and an emotion word may be predicted by using a masked language model (MLM), to identify an emotion polarity of the text. Alternatively, a prefix may be constructed as “English: I missed the bus today. Chinese: [MASK] [MASK]”, and then a generation model is used to obtain corresponding Chinese translation.

Transformer model: The transformer model is a deep learning model using a self-attention mechanism, and by applying the attention mechanism, different weights can be allocated based on different importance of parts of input data. This model is mainly used in fields of natural language processing (NLP) and computer vision (CV).

Attention mechanism: The attention mechanism is a problem-solving solution proposed to imitate human attention. In brief, the mechanism is to quickly screen out high-value information from a large amount of information. This mechanism is mainly used for resolving a problem that when an input sequence of a long short term memory (LSTM) model/a recursive neural network (RNN) model is long, it is very difficult to obtain a proper final vector representation. A main method is to retain an intermediate result of the LSTM, use a new model to learn the intermediate result, and associate the intermediate result with an output, to achieve an objective of information screening.

Bidirectional encoder representations from transforms (BERT) model: The BERT model is a pre-trained language representation model, which emphasizes that pre-training is no longer performed by using a suitable unidirectional language model or shallowly splicing two unidirectional language models as in the past, but a new language model with a mask mechanism is used, to generate deep bi-directional language representation.

Generative pre-trained transformer (GPT): The GPT model is an autoregressive language model that is used to generate, by deep learning, natural language that can be understood by humans.

Knowledge graph: The knowledge graph is essentially a knowledge base referred to as a semantic network, that is, a knowledge base with a directed-graph structure. The knowledge graph is a data structure including entities, relationships, and attributes.

Over fitting: Over fitting means that a difference between a training error and a testing error is excessively large. In other words, complexity of a model is higher than that of an actual problem, and the model performs well on a training set but poorly on a test set.

Artificial intelligence (AI): AI is a theory, a method, a technology, and an application system that uses a digital computer or a machine controlled by the digital computer to simulate, extend, and expand human intelligence, perceive an environment, obtain knowledge, and use the knowledge to obtain an optimal result. In other words, artificial intelligence is a comprehensive technology in computer science, and attempts to understand essence of intelligence and produce a new intelligent machine that can react in a manner similar to human intelligence. Artificial intelligence is to study design principles and implementation methods of various intelligent machines, to enable machines with functions of perception, reasoning, and decision-making. Artificial intelligence software technologies mainly include several major directions, such as a computer vision technology, a speech processing technology, a natural language processing technology, and machine learning/deep learning. In the solution of the present disclosure, a multimedia recall task is converted into a text generation task by using the natural language processing technology, to improve multimedia recall accuracy.

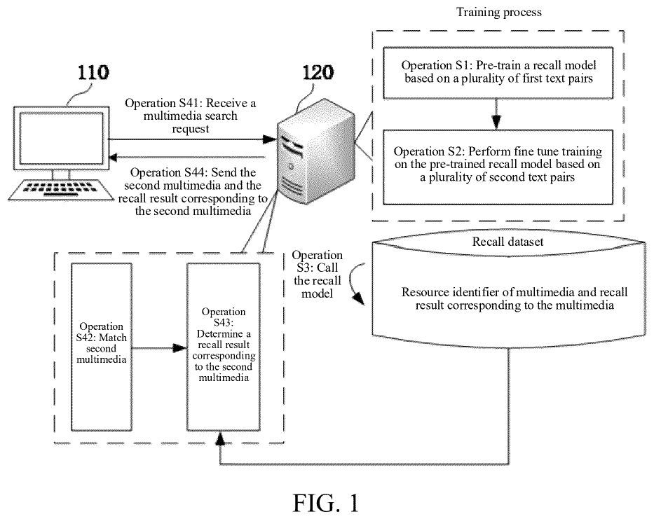

FIG. 1 is a schematic diagram of an application scenario of the present disclosure according to an embodiment of the present disclosure. As shown in FIG. 1, the application scenario includes a server 120. The server 120 may be a physical server, or may be a cloud server, and is not specifically limited herein.

The server 120 may train a recall model based on a recall model training method provided in the present disclosure, and a training process includes the following operations: Operation S1: Pre-train the recall model based on a plurality of first text pairs. Operation S2: Perform fine tune training on the pre-trained recall model based on a plurality of second text pairs. Based on the recall model obtained after the fine tune training, operation S3 may be performed: Call the recall model to perform recall processing on each multimedia in a multimedia library, in other words, determine, by using the recall model based on a resource identifier corresponding to multimedia, a recall result corresponding to the multimedia, and associatively store the resource identifier of the multimedia and the recall result corresponding to the multimedia into a recall dataset. The recall result corresponding to the multimedia indicates related multimedia that is related to the multimedia. In a specific embodiment, operation S3 can be performed offline.

Based on the recall dataset, the server 120 may provide a search recall service for a terminal. In this case, the application scenario further includes a terminal 110. The terminal 110 may be a smartphone, a tablet computer, a notebook computer, a desktop computer, an on board terminal, a smart television, or the like, which is not specifically limited herein.

The terminal 110 is in communication connection with the server 120 through a wired or wireless network, and the server 120 performs search recall based on the following process: Operation S41: Receive a multimedia search request. Operation S42: Match second multimedia, where specifically, the multimedia search request sent by the terminal 110 includes a search keyword, and the second multimedia matching the search keyword is determined by matching the search keyword with description information of each multimedia in the multimedia library. Operation S43: Determine a recall result corresponding to the second multimedia, where specifically, the recall result corresponding to the second multimedia is obtained from the recall dataset. Operation S44: Send the second multimedia and the recall result corresponding to the second multimedia.

In some embodiments, training of the recall model, calling of the recall model to determine the recall result of each multimedia, and providing a recall search service to a terminal may be performed by a same electronic device, for example, all performed by the server 120; or may be performed by different electronic devices. This is not specifically limited herein.

Implementation details of the technical solution in this embodiment of the present disclosure are described in detail in the following;

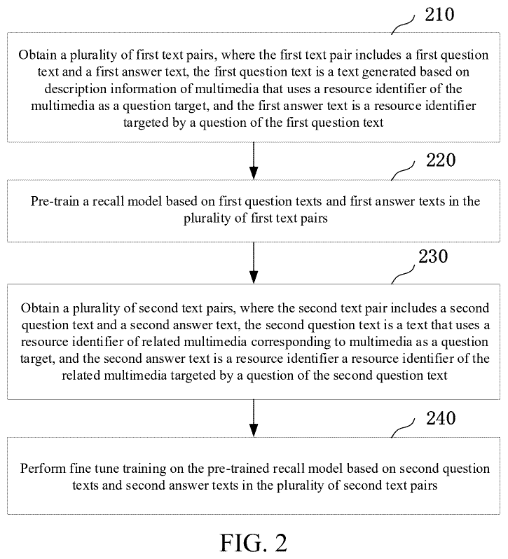

FIG. 2 is a flowchart of a recall model training method according to an embodiment of the present disclosure. The method may be performed by an electronic device with a processing capability. The electronic device is, for example, a server, and this is not specifically limited herein. With reference to FIG. 2, the method includes at least operation S210 to operation S240. Detailed descriptions are as follows:

Operation 210: Obtain a plurality of first text pairs, where the first text pair includes a first question text and a first answer text; and the first question text is a text generated based on description information of multimedia that uses a resource identifier of the multimedia as a question target, and the first answer text is a resource identifier targeted by a question of the first question text.

The first text pair is a text pair used for pre-training a recall model. A question text in the first text pair that represents a question is referred to as the first question text, and an answer text in the first text pair that represents an answer to the question is referred to as the first answer text.

The multimedia may be a video (for example, a long video, or a medium-long video), an audio, an audio and video, or the like, for example, may be a video such as a TV series, a documentary, a movie, a variety show, a cartoon, or an animation. The description information of the multimedia is used to indicate basic attributes of the multimedia. The basic attributes of the multimedia may be a multimedia name (for example, a TV series name, a documentary name, a movie name, and a cartoon name), a release time, a language, a scriptwriter, a director, a brief introduction, a leading actor, a type, and the like.

In some embodiments, the description information of the multimedia may be stored in a form of a knowledge graph, that is, the description information of the multimedia is presented in a directed graph structure. Using a movie of The X as an example, a schema of the description information of the multimedia may be shown as follows:

```
{
  “channel”: “movie”,
  “alias”: [
    “A Spin-off Movie of The X”
  ],
  “year”: “2019”,
  “area”: [
    “Chinese Mainland”
  ],
  “language”: [
    “Mandarin”
  ],
```

“summary”: Near Qishan Mountain, there is a little town called Fu Feng, which is nicknamed the “City That Never Turns Dark” . . . . The two decide to work together and solve the mystery to capture the culprit behind the mysterious incidents. “,

```
“produce”: [
  “Guizhou XX Media Corporation Limited”,
  “Guangzhou YY Media Corporation Limited”
],
“series_name”: “The X”,
“kgid”: “kg_41753519”,
“serial_version”: “0”,
“kgid_name”: “The X - The Living Dead”,
“english_title”: “The Living Dead”,
“publish_time_in_source”: “2020-06-27 00:00:00”,
“season_num”: “”,
“entity_type”: “movie”,
“actors”: [
  {
    “id”: “151110”,
    “name”: “Yu XX”,
    “type”: “leading”
  },
  {
    “id”: “8253725”,
    “name”: “Zheng XX”,
    “type”: “leading”
  },
  {
    “id”: “1541022”,
    “name”: “Wang XX”,
    “type”: “leading”
  }.
```

In a schema corresponding to the multimedia, namely, the movie The X, description information of different types is represented through description fields (a description field is used to represent a basic attribute) and values of the description fields. The description fields are, for example, a description field “year” representing a release time, a description field “summary” representing a brief introduction, and a description field “actors” representing actors. In another embodiment, the description information of the multimedia may further include more or fewer description fields than those listed above, which are not specifically limited herein.

The resource identifier is a text string used for uniquely identifying the multimedia, and the resource identifier may be a content identification (CID) of the multimedia. The content identification of the multimedia is obtained by performing encryption processing (for example, cryptographic hash processing) on multimedia content, and the content identification is equivalent to a “content fingerprint” of the multimedia.

The first question text uses the resource identifier of the multimedia as the question target, that is, the first question text is used to ask for the resource identifier of the multimedia. For example, the first question text may be: What is a CID of XX? “XX” in the first question text may be at least one qualifier used for limiting the multimedia. For example, “XX” may be a basic attribute such as a multimedia name, a leading actor, a release time, a scriptwriter, a director, or a type.

In some embodiments, a first question text and a first answer text in each first text pair may be determined based on the following operation A1 to operation A3:

Operation A1: Obtain description information of multimedia and a resource identifier corresponding to the multimedia.

Operation A2: Generate, based on a value of at least one description field in the description information, a first question text that uses the resource identifier of the multimedia as a question target.

As described above, a description field in the description information of the multimedia is used to represent a basic attribute, and a value of the description field in the description information represents attribute content of the multimedia under a corresponding attribute. In operation A2, the multimedia is limited by the value of at least one description field in the description information, and the first question text that uses the resource identifier of the multimedia as the question target is generated based on the value. For example, the first question text may be: What is a CID corresponding to the spin-off movie of The X? In the first question text, “the spin-off movie of The X” is a value of a description field indicating a movie name.

In some embodiments, operation A2 includes the following operation B1 to operation B3. Detailed descriptions are as follows:

Operation B1: Obtain a first question template, where the first question template uses the resource identifier as a question target, and the first question template indicates at least one description field.

In the present disclosure, a question template used to generate the first question text is referred to as the first question template. The first question template may be preset, and a quantity of first question templates is not limited. To ensure richness of the first question text generated, the quantity of first question templates may be multiple.

The first question template indicates common question content in the first question text. The common question content is, for example, “What is a corresponding CID”. In addition, the first question template further indicates at least one description field used for limiting the multimedia. For example, the description field indicated by the first question template that is used for limiting the multimedia may be a description field indicating a multimedia name, a description field indicating a leading actor corresponding to the multimedia, or a description field indicating a director corresponding to the multimedia. Common question content in different first question templates may be the same, but description fields indicated by the templates are different. In this way, a plurality of first question texts can be generated based on description information of same multimedia and by using different first question templates.

Operation B2: Obtain, from the description information of the multimedia, a value of each description field indicated by the first question template.

Based on the first question template, the value of each description field indicated by the first question template can be obtained from description information of each multimedia in a multimedia library. For example, if a description field indicated by the first question template includes a description field indicating a leading actor, a value of the description field indicating the leading actor is correspondingly obtained from the description information of the multimedia, where the value indicates the leading actor corresponding to the multimedia.

Operation B3: Combine the obtained value of the description field with the first question template, to obtain the first question text.

In operation B3, the obtained value of the description field is filled in a position of the description field in the first question template, to correspondingly obtain the first question text.

For example, the first question template may be: What is a CID corresponding to [description field II] in which [description field I] is a leading actor? In the example, the description field I is a description field representing a leading actor, and the description field II is a description field representing a multimedia name. The following first question text may be generated based on the first question template: What is a CID corresponding to YYYY in which Liu XX is a leading actor?

For another example, the first question template may be: What is a CID corresponding to [description field II] in which [description field III] is a director? In the example, the description field III is a description field indicating a director. The following first question text may be generated based on the first question template: What is a CID corresponding to ZZZ in which Zhang XX is a director?

The first question templates listed above are merely exemplary examples, and cannot be considered as limitations on the application scope of the present disclosure. In a specific embodiment, to enrich forms of the first question text, more first question templates may be set.

Based on the value of the description field indicated by the first question template, the first question text can be efficiently generated based on multi-modal description information. In addition, because the quantity of first question templates may be multiple, richness of the generated first question text is further ensured, and pre-training quality of the recall model is improved.

Operation A3: Use the resource identifier of the multimedia as the first answer text corresponding to the first question text.

For example, for the first question text: What is a CID corresponding to ZZZ in which Zhang XX is a director? A first answer text corresponding to this first question text is a resource identifier corresponding to multimedia ZZZ in which Zhang XX is the director, for example, the first answer text is klv6811ljzbhs8k.

For another example, for the first question text: What is a CID corresponding to YYYY in which Liu XX is a leading actor? A corresponding first answer text is: mzc002003515vcf, and “mzc002003515vcf” is a resource identifier of multimedia YYYY in which Liu XX is the leading actor.

In some embodiments, quantities of question targets for the first question text are different. The first question templates may be classified into a primary requirement scenario template and an intention scenario template. The primary requirement scenario template aims at one question target, that is, a resource identifier of certain multimedia is used as the question target, and the intention scenario template uses resource identifiers of at least two multimedia as the question target. In other words, a quantity of multimedia limited by a description field in the primary requirement scenario template is one, and a quantity of multimedia limited by a description field in the intention scenario template is at least two.

For example, in the foregoing “What is a CID corresponding to YYYY in which Liu XX is a leading actor?” and “What is a CID corresponding to ZZZ in which Zhang XX is a director?”, the first question template corresponding to the two first question texts may be considered as a primary requirement scenario template.

An intention scenario template is, for example: What is a CID corresponding to a movie series [description field IV]? The description field IV is a description field indicating a series name of a series to which the multimedia belongs. Based on the intention scenario template, the following first question text may be generated: What is a CID corresponding to a movie series The X? A first answer text corresponding to this first question text is: mzc002001pxf8uq.

For each multimedia in the multimedia library, a plurality of first text pairs may be correspondingly generated for each multimedia based on the foregoing process by using description information of the multimedia.

As description fields can identify description information in different dimensions, multimedia can be accurately expressed by using a value of at least one description field in the description information. In this way, a constructed first question text is more strongly associated with the multimedia, and generation quality of the first question text is improved.

Operation 220: Pre-train a recall model based on first question texts and first answer texts in the plurality of first text pairs.

The recall model is a Seq2Seq model constructed by using a neural network, that is, the recall model can map an input sequence to an output sequence. In the present disclosure, in a pre-training process, the input sequence of the recall model is the first question text, and the output sequence is an answer text representing the resource identifier of the multimedia.

In the pre-training process, the first question text is inputted into the recall model; the recall model performs semantic encoding on the first question text, and then performs decoding based on a semantic encoding result to output a predicted resource identifier of the multimedia. Subsequently, a first loss is calculated based on the outputted predicted resource identifier of the multimedia and the resource identifier in the first answer text corresponding to the first question text, and then a weight parameter of the recall model is reversely adjusted based on the first loss.

In some embodiments, a pre-training end condition may be preset. The pre-training end condition may be that a quantity of pre-training iterations reaches a first time threshold, or that a loss function in a pre-training stage converges, or the like. This is not specifically limited herein. In the pre-training process, if the pre-training end condition is determined to be met, the pre-training stops.

As the first question text is generated based on the description information of the multimedia, and the first answer text is the resource identifier of the multimedia, by pre-training the recall model based on the first question text and the first answer text, the recall model can learn feature representation of the resource identifier of the multimedia, that is, learn an association relationship between the resource identifier of the multimedia and the description information of the multimedia. In this way, the recall model can perceive and memorize description information corresponding to multimedia of different resource identifiers, and further, the resource identifier of the multimedia can be described by using the description information of the multimedia.

Operation 230: Obtain a plurality of second text pairs, where a second text pair includes a second question text and a second answer text, and the second question text is a text that uses a resource identifier of related multimedia corresponding to the multimedia as a question target, and the second answer text is a resource identifier of the related multimedia that is targeted by a question of the second question text.

The second text pair is a text pair used for performing fine tune training on the recall model. A question text in the second text pair that represents a question is referred to as the second question text, and an answer text in the second text pair that represents an answer is referred to as the second answer text.

Related multimedia corresponding to multimedia A refers to multimedia associated with the multimedia A in one or more dimensions, for example, multimedia having a high similarity (such as highly similar content or a same type) with the multimedia A, or multimedia associated with content of the multimedia A, or multimedia similar to the multimedia A that a user is more interested in, or multimedia similar to the multimedia A that a user is more inclined to pay attention to.

The second question text uses the resource identifier of the related multimedia corresponding to the multimedia as the question target, that is, the second question text is used to ask for the resource identifier of the related multimedia corresponding to the multimedia. In some embodiments, the second question text indicates multimedia used as reference. For example, if the second question text uses a resource identifier of related multimedia corresponding to the multimedia A as the question target, the multimedia used as reference is the multimedia A. In some embodiments, in the second question text, the resource identifier of the multimedia used as reference may be used to indicate the multimedia used as reference. For example, the second question text may be: Search for what a CID that a user whose CID is mzc002000mqs1cp also tends to click on is? The resource identifier “mzc002000mqs1cp” in the second question text is used to limit multimedia used as reference, and the second question text is used to ask for a resource identifier of related multimedia corresponding to multimedia “mzc002000mqs1cp”.

In some embodiments, the second question text and the second answer text in the second text pair may be determined based on the following operation C1 to operation C3. Detailed descriptions are as follows:

Operation C1: Obtain multimedia feedback data, where the multimedia feedback data indicates at least two multimedia for which a feedback operation is triggered within set duration.

The feedback operation may be an interaction operation on multimedia when the multimedia is presented, and may be a clicking operation, a thumbs-up operation, a collection operation, a forwarding operation, or the like, which is not specifically limited herein. In some embodiments, after a multimedia cover is presented on a user interface, an operation log of a client for the multimedia cover may be collected. The operation log indicates a feedback operation triggered by a user for the multimedia cover. Then, based on the operation log within a time period, at least two multimedia for which the feedback operation is triggered within set duration is determined. When the operation log of the client for the multimedia cover needs to be collected, permission or consent from the user needs to be obtained for every operation, and collection, use, and processing of the operation log need to comply with related laws and regulations and standards of related countries and regions.

In some embodiments, in a scenario of multimedia searched for by a user, based on multimedia found through matching (for ease of distinguishing, the multimedia found is referred to as third multimedia), at least one fourth multimedia having a high similarity with the third multimedia may be further matched from the multimedia library, and the third multimedia and the at least one fourth multimedia are pushed to a search initiator, to display the third multimedia and the at least one fourth multimedia on a search result display page. Subsequently, another multimedia that the user clicks on within set duration after the user clicks on the third multimedia may be determined by using the operation log collected from the client. In a search scenario, what the user is most concerned with and interested in is the third multimedia that matches a search word. If the user further clicks on the fourth multimedia displayed on the search result display page, it indicates that the user is also concerned with the fourth multimedia on which the clicking operation is triggered. In this case, the multimedia feedback data is a plurality of clicking operation logs on the search result display page. The multimedia feedback data correspondingly reflects at least two multimedia on which the clicking operation is triggered within the set duration.

Operation C2: Generate, based on a resource identifier corresponding to first multimedia in the at least two multimedia, the second question text that uses a resource identifier of related multimedia corresponding to the first multimedia as the question target, where the related multimedia corresponding to the first multimedia includes at least one multimedia other than the first multimedia in the at least two multimedia.

In other words, in operation C2, one of the at least two multimedia on which the feedback operation is triggered within the set duration indicated by the multimedia feedback data is considered as the first multimedia, and multimedia other than the first multimedia in the at least two multimedia is considered as the related multimedia corresponding to the first multimedia.

In the second question text, the first multimedia is represented or limited by using the resource identifier corresponding to the first multimedia, and based on this, the resource identifier of the related multimedia corresponding to the first multimedia is used as the question target. For example, the second question text may be: What is a CID of multimedia that attracts a user who is also interested in a CID of XX? “XX” in the second question text refers to a CID of the first multimedia.

In a search scenario, that is, when the multimedia feedback data is a plurality of clicking operation logs on the search result display page, the third multimedia found through matching may be used as the first multimedia, and correspondingly, the fourth multimedia that is clicked on indicated by the clicking operation logs is used as related multimedia of the third multimedia.

In some embodiments, operation C1 includes the following operation D1 and operation D2. Detailed descriptions are as follows:

Operation D1: Obtain a second question template, where the second question template uses the resource identifier of the related multimedia as a question target.

The second question template is a question template set for the second question text.

The second question template may be preset, and a quantity of the second question template may be one or multiple. Similarly, the second question template indicates common question content in the second question text. In other words, if a plurality of second question texts are generated based on a same second question template, common question content in the plurality of second question texts is the same. The second question template further indicates a position of the resource identifier of the multimedia used as reference in the second question text. If the second question text uses the resource identifier of the related multimedia corresponding to the multimedia A as the question target, the resource identifier of the multimedia A is used as reference.

The second question template may be: What is a CID of multimedia that attracts a user who is also interested in a CID of XX? For another example, the second question template may be: What is a CID that a user, who searches for CID: XX, is also inclined to click on? For still another example, the second question template may be: What is a CID that a user, who is concerned with CID: XX, is also concerned with? A position of “XX” in foregoing second question template is a position of the resource identifier of the multimedia used as reference. Certainly, the foregoing is merely an exemplary example of the second question template, and cannot be construed as a limitation to the application scope of the present disclosure.

Operation D2: Combine the resource identifier corresponding to the first multimedia of the at least two multimedia with the second question template, to obtain the second question text.

As described above, the second question template indicates the position of the resource identifier of the multimedia used as reference in the second question text. Therefore, the resource identifier corresponding to the first multimedia is correspondingly used as reference to fill in a corresponding position in the second question template, to obtain the second question text.

The second question text can be quickly and conveniently generated based on the second question template. In addition, because a quantity of second question templates may be multiple, richness of the generated second question text is further ensured, and pre-training quality of the recall model is improved.

Operation C3: Use the resource identifier of the related multimedia corresponding to the first multimedia as the second answer text corresponding to the second question text.

The first multimedia may be correspondingly determined based on the multimedia feedback data, and at least one multimedia other than the first multimedia in the at least two multimedia for which feedback operation is triggered indicated by the multimedia feedback data is used as the related multimedia of the first multimedia. The resource identifier of the related multimedia corresponding to the first multimedia may be correspondingly determined based on stored resource identifier of each multimedia. Therefore, the second answer text corresponding to the second question text is correspondingly determined.

Based on the foregoing operation C1 to operation C3, the following second question-answer pair may be determined. The second question text is: What is a CID that a user, who searches for CID: mzc002000mqs1cp, is also inclined to click on? The second answer text is: mzc0020028aguo0. “mzc002000mqs1cp” in the second question text is the resource identifier of the multimedia used as reference (that is, the resource identifier of the first multimedia); “mzc0020028aguo0” in the second answer text is the resource identifier of the related multimedia corresponding to the first multimedia.

In a training process, the second text pair enables the recall model to learn relevance knowledge between different multimedia, and the at least two multimedia in the multimedia feedback data can just reflect relevance of the multimedia based on the feedback operation within the set duration. For example, relevance exists between the first multimedia and multimedia other than the first multimedia. Therefore, the second text pair determined on this basis can effectively improve training quality of the recall model.

In some embodiments, to ensure a quantity of second text pairs, the second text pairs may be determined based on multimedia feedback data in a plurality of time periods (for example, a plurality of time periods in last 30 days). In this way, sufficient training samples in a fine tune training stage are ensured.

Operation 240: Perform fine tune training on the pre-trained recall model based on second question texts and second answer texts in the plurality of second text pairs.

In a fine tune training process, an input sequence of the pre-trained recall model is the second question text, and an output sequence is an answer text representing the resource identifier of the related multimedia corresponding to the multimedia. In the fine tune training process, the second question text is inputted into the pre-trained recall model; the pre-trained recall model performs semantic encoding on the second question text, and then performs decoding based on a semantic encoding result to output a predicted resource identifier of the related multimedia. Subsequently, a second loss is calculated based on the outputted predicted resource identifier of the related multimedia and the resource identifier in the second answer text corresponding to the second question text, and then a weight parameter of the recall model is reversely adjusted based on the second loss.

After the pre-training ends, the recall model learns an association relationship between the resource identifier of the multimedia and the description information of the multimedia, and constructs feature representation of the resource identifier of the multimedia by using a feature corresponding to the description information of the multimedia. On this basis, the fine tune training is performed on the pre-trained recall model based on the second question text that uses the resource identifier of the related multimedia corresponding to the multimedia as the question target, and based on the second answer text that includes the resource identifier of the related multimedia corresponding to the multimedia. In this way, the recall model can use the association relationship between the resource identifier of the multimedia and the description information of the multimedia that the recall model learned in the pre-training stage, to learn, based on the resource identifier of the multimedia and the resource identifier of the related multimedia corresponding to the multimedia in the fine tune training stage, feature commonality between the multimedia used as reference and the related multimedia corresponding to the multimedia. Therefore, in a subsequent application process, the recall model can accurately recall, based on the resource identifier of the multimedia used as reference, the related multimedia corresponding to the multimedia, that is, accurately predict the resource identifier of the related multimedia corresponding to the multimedia.

In some embodiments, based on pre-training the recall model, to reduce training time and improve training efficiency, in the fine tune training process, weight parameters of some network layers in the recall model may be reversely adjusted based on the second loss. Specifically, because parameters of a plurality of network layers closest to an output of the recall model are directly related to a recall task of the recall model, weight parameters of a last network layer (namely, an output layer) and a plurality of network layers before the last network layer in the recall model may be reversely adjusted based on the second loss in the fine tune training stage. In this way, compared with adjusting weight parameters of all the network layers of the recall model, adjusting weight parameters of some network layers in the recall model reduces time, and correspondingly, can reduce fine tune training duration. The weight parameters of the last network layer (namely, the output layer) and the plurality of network layers before the last network layer in the recall model are reversely adjusted. In this way, a powerful generalization capability of a deep neural network can be effectively utilized, a complex model design is omitted, and time consumption of training is reduced.

In some embodiments, a fine tune training end condition may be preset. The fine tune training end condition may be that a quantity of fine tune training iterations reaches a second time threshold, or that a loss function in a fine tune training stage converges, or the like. This is not specifically limited herein. In the fine tune training process, if the fine tune training end condition is determined to be met, the fine tune training stops.

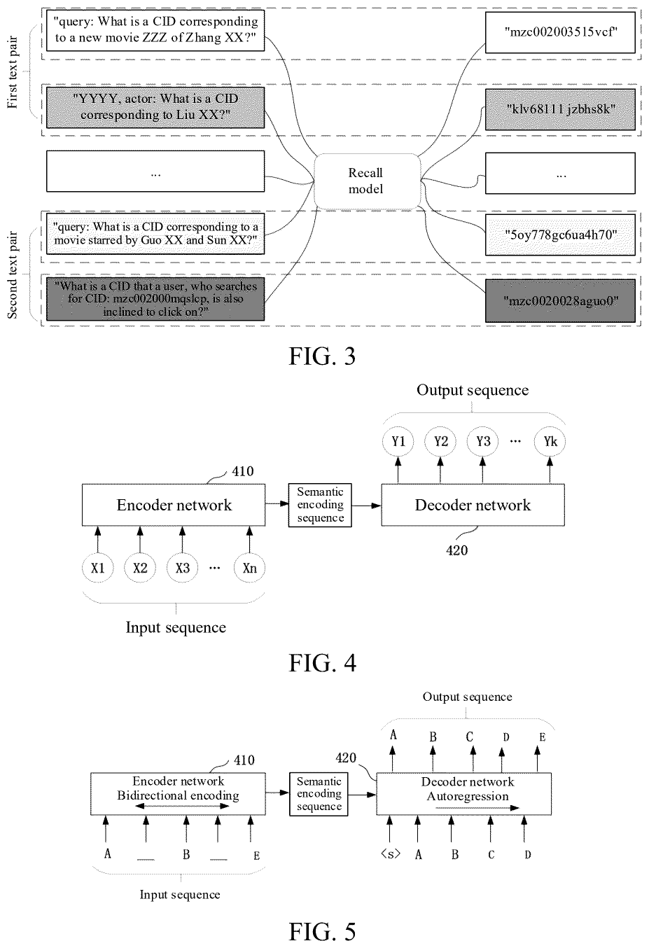

FIG. 3 is a schematic diagram of training a recall model according to an embodiment of the present disclosure. FIG. 3 exemplarily shows two first text pairs and two second text pairs. In a first text pair, a text on the left is a first question text, a text on the right is a first answer text, and both texts on the left and on the right located in a same dashed box (or a same row) belong to a same text pair (that is, belong to a first text pair or belong to a second text pair). For a process of pre-training the recall model by using the first text pair and performing fine tune training on the pre-trained recall model by using the second text pair, refer to the foregoing descriptions, and details are not described herein again.

In the present disclosure, the recall model is first pre-trained based on a plurality of first text pairs. As the first question text in the first text pair is generated based on description information of multimedia, the first question text uses a resource identifier of the multimedia as a question target, and a first answer text is the resource identifier of the multimedia, the process is equivalent to pre-training the recall model by using graph priori knowledge of the multimedia, so that the recall model can perceive and memorize the description information of the multimedia. Through pre-training, the recall model can learn an association relationship between the resource identifier of the multimedia and the description information of the multimedia, to determine feature representation of the resource identifier of the multimedia based on a feature of the description information of the multimedia. After the pre-training ends, the fine tune training is performed on the pre-trained recall model based on the second question text that uses a resource identifier of related multimedia corresponding to the multimedia as a question target, and based on the second answer text that includes the resource identifier of the related multimedia corresponding to the multimedia. In this way, the recall model can use the association relationship between the resource identifier of the multimedia and the description information of the multimedia that the recall model learned in the pre-training stage, to learn, based on the resource identifier of the multimedia and the resource identifier of the related multimedia corresponding to the multimedia in the fine tune training stage, feature commonality between the multimedia used as reference and the related multimedia corresponding to the multimedia. In a subsequent application process, the recall model can accurately recall, based on the resource identifier of the multimedia used as reference, the related multimedia corresponding to the multimedia, that is, accurately predict the resource identifier of the related multimedia corresponding to the multimedia. In addition, according to the solution of the present disclosure, a multimedia recall task is converted into a text generation task. In this way, a video frame or an audio frame in the multimedia does not need to be processed, so that the multimedia recall task is simplified, and recall efficiency is improved.

In some embodiments, to facilitate construction of a first text pair and a second text pair, a multimedia data table may be adjusted. An original multimedia data table includes a value of multimedia in each description field, but does not include a resource identifier of the multimedia. Therefore, the resource identifier of the multimedia may be added to the multimedia data table before pre-training, and a periodic full update is performed on information in the multimedia data table based on multimedia in a multimedia database. For example, when multimedia is newly added or subtracted from the multimedia library, data in the multimedia data table is correspondingly updated. Then, the first text pair and the second text pair may be constructed based on the data in the multimedia data table. After the recall model is pre-trained by using the first text pair, the recall model may learn feature representation of each resource identifier in the multimedia data table. The feature representation of resource identifiers is embodied through a feature of description information of multimedia corresponding to the resource identifiers. If a quantity of the multimedia in the multimedia library is large, a quantity of resource identifiers in the multimedia data table is also large. In this case, a training and online inference speed may be slow, and a cold start may be difficult. In practice, it is found that if the quantity of the resource identifiers is maintained on a scale of a million, learning of the feature representation of the resource identifiers may satisfy requirements on training duration and the online inference speed.

FIG. 4 is a schematic diagram of a structure of a recall model according to an embodiment of the present disclosure. As shown in FIG. 4, the recall model includes an encoder network 410 and a decoder network 420. The encoder network 410 is configured to perform semantic encoding on an input sequence, and output a semantic encoding sequence. The decoder network is configured to decode the semantic encoding sequence outputted by the encoder network, to obtain an output sequence. Specifically, in the present disclosure, in a pre-training stage, the input sequence is a first question text, and the output sequence is a predicted resource identifier of multimedia. In a fine tune training stage, the input sequence is a second question text, and the output sequence is a predicted resource identifier of related multimedia corresponding to the multimedia.

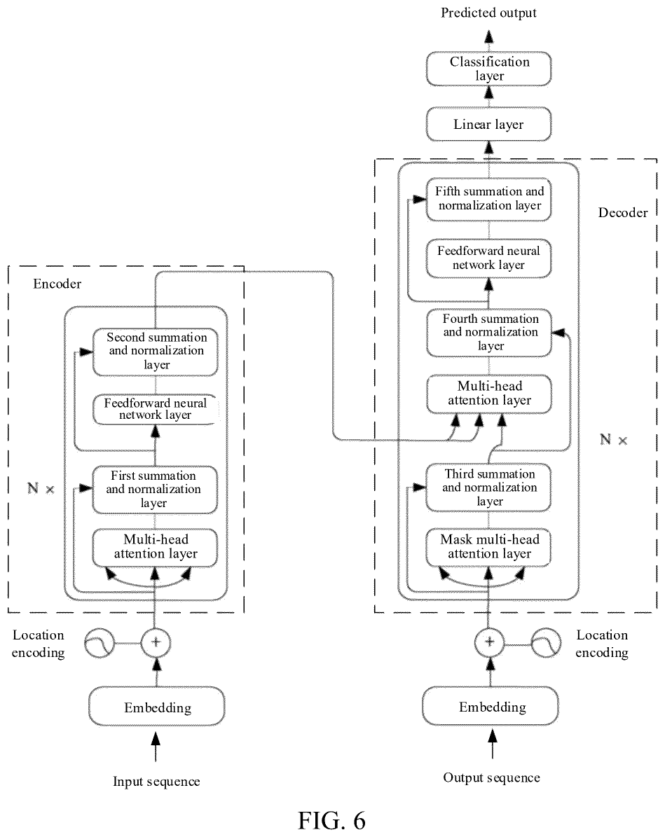

In some embodiments, the recall model may be a bidirectional and auto-regressive transformer (BART) model. The BART model integrates features of bidirectional encoding of the BERT model and left-to-right decoding of the GPT model, and is based on a standard Seq2Seq transformer model. Therefore, the BART model is more suitable for a text generation scenario than the BERT model, and has additional bidirectional context information compared with the GPT model. FIG. 5 exemplarily shows a schematic diagram of encoding and decoding processing performed by using the BART model. As shown in FIG. 5, after an input sequence is inputted to the encoder network 410, the encoder network 410 performs bidirectional encoding on the input sequence, to output a semantic encoding sequence. Then, the decoder network 420 performs autoregressive decoding (that is, unidirectional decoding from left to right), to obtain an output sequence. In the BART model, an input sequence of an encoder network does not need to be aligned with an output sequence of a decoder network, and the input sequence of the encoder network is allowed to be pre-processed. An example of pre-processing is that characters at some positions in the input sequence are replaced with mask symbols. For example, a character after “A” and a character after “B” in the input sequence in FIG. 5 are both replaced with mask symbols.

The BART model uses an attention mechanism and a transform model structure. In an application scenario of the present disclosure, considering that a data volume of a multimedia library is on a scale of a million, and considering resource consumption, an encoder network in a recall model includes an encoder in a three-layer transformer model, and a decoder network in the recall model includes a decoder in the three-layer transformer model. FIG. 6 exemplarily shows a schematic diagram of a transformer model. As shown in FIG. 6, an encoder in the transformer model includes a multi-head attention layer, a first summation and normalization layer, a feedforward neural network layer, and a second summation and normalization layer. A residual connection is established between the multi-head attention layer and the first summation and normalization layer, and a residual connection is established between an input of the feedforward neural network layer and the second summation and normalization layer. A decoder in the transformer model includes a mask multi-head attention layer, a third summation and normalization layer, a multi-head attention layer, a fourth summation and normalization layer, a feedforward neural network layer, and a fifth summation and normalization layer. A residual connection is established between an input of the mask multi-head attention layer and the third summation and normalization layer, a residual connection is established between an input of the multi-head attention layer and the fourth summation and normalization layer, and a residual connection is established between an input of the feedforward neural network layer and the fifth summation and normalization layer.

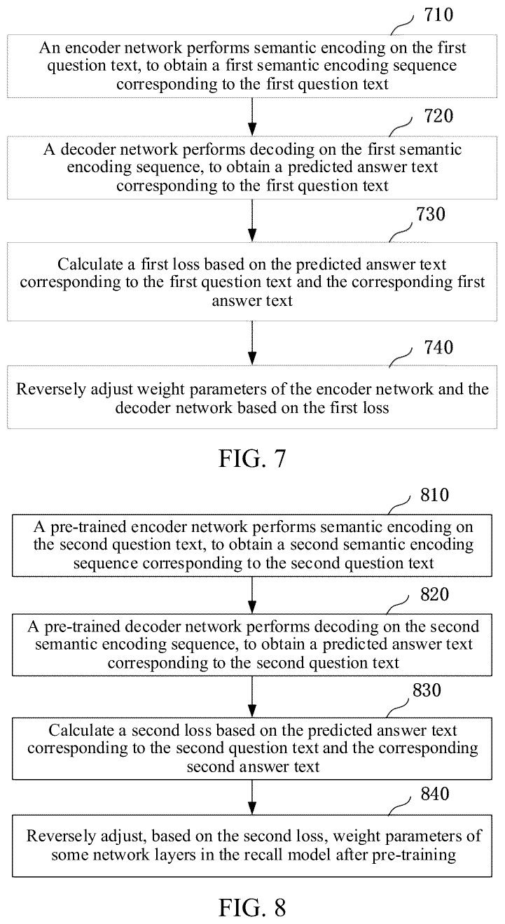

In some embodiments, as shown in FIG. 7, operation 220 includes the following operation 710 to operation 740. Detailed descriptions are as follows:

Operation 710: An encoder network performs semantic encoding on the first question text, to obtain a first semantic encoding sequence corresponding to the first question text.

Specifically, the encoder network may perform, based on an attention mechanism (for example, a multi-head attention mechanism), semantic encoding on the first question text, to fully use context information in the first question text, and ensure accuracy of the obtained first semantic encoding sequence.

Operation 720: A decoder network performs decoding on the first semantic encoding sequence, to obtain a predicted answer text corresponding to the first question text.

The predicted answer text decoded and outputted by the decoder network includes a resource identifier of multimedia obtained through prediction that the first question text asks for.

Operation 730: Calculate a first loss based on the predicted answer text corresponding to the first question text and the corresponding first answer text.

A loss function of the recall model in the pre-training stage may be preset. For ease of distinguishing, the loss function set for the recall model in the pre-training stage is referred to as a first loss function. The first loss function may be a cross-entropy loss function, an absolute value loss function, a mean square deviation loss function, or the like, which is not specifically limited herein. On this basis, the predicted answer text corresponding to the first question text and the corresponding first answer text may be substituted into the first loss function, to calculate the first loss. The first loss reflects a difference between the predicted answer text corresponding to the first question text and the first answer text corresponding to the first question text.

In a specific embodiment, the first loss function may be a cross-entropy loss function. An expression of the cross-entropy loss function is shown in the following formula 1:

$$l ( p , q ) = - {\sum }_{i = 1}^{K} {q}_{i} log {p}_{i} ; \qquad ( formula 1 )$$

In the formula, K represents a quantity of all classifications. qᵢ represents a true label of a sample. Pᵢ represents a predicted probability that the sample belongs to a Class i. If the Class i indicates a class in which the predicted answer text is the same as an actual answer text, Pᵢ indicates a probability that the predicted answer text predicted for the first question text is the same as the first answer text corresponding to the first question text. In the formula, Pᵢ may be determined by using a softmax function and according to the following formula 2:

$${p}_{i} = \frac{exp ( {z}_{i} )}{{\sum }_{j = 1}^{K} exp ( {z}_{j} )} ; \qquad ( formula 2 )$$

In the formula, Zⱼ represents a confidence score at which the predicted answer text corresponds to a Class j.

Operation 740: Reversely adjust weight parameters of the encoder network and the decoder network based on the first loss.

In a specific embodiment, the weight parameters of the encoder network and the decoder network may be adjusted in a gradient descent method based on the first loss, to minimize the first loss function.

For each first sample pair, pre-training is iteratively performed on the recall model based on a process shown in operation 710 to operation 740, until a pre-training end condition is met.

In some embodiments, as shown in FIG. 8, operation 240 includes the following operation 810 to operation 840. Detailed descriptions are as follows:

Operation 810: A pre-trained encoder network performs semantic encoding on the second question text, to obtain a second semantic encoding sequence corresponding to the second question text.

Operation 820: A pre-trained decoder network performs decoding on the second semantic encoding sequence, to obtain a predicted answer text corresponding to the second question text.

The predicted answer text corresponding to the second question text includes a resource identifier of related multimedia targeted by the second question text that is obtained through prediction.

Operation 830: Calculate a second loss based on the predicted answer text corresponding to the second question text and the corresponding second answer text.

Similarly, a second loss function of the recall model in the fine tune training stage may be preset. The second loss function may be set based on an actual requirement, and is not specifically limited herein. Then, the predicted answer text corresponding to the second question text and the corresponding second answer text are substituted into the second loss function, to calculate the second loss. The second loss reflects a difference between the predicted answer text corresponding to the second question text and the corresponding second answer text.

In some embodiments, to alleviate an overfitting problem, the second loss function may be a cross-entropy loss function with label smoothing. The cross-entropy loss function with label smoothing is the same as formula 1. However, in the cross-entropy loss function with label smoothing, qᵢ is determined according to the following formula 3:

$${q}_{i} = \{ \begin{matrix}1 - ε : & if i = y \\ ε / ( K - 1 ) : & otherwise\end{matrix} ; \qquad ( formula 3 )$$

In the formula, K represents a total quantity of classifications of multi-classification. is a small hyperparameter, and € may be preset. y represents a positive sample, that is, if a first answer text in a first text pair is an answer to a first question text, the sample corresponds to qᵢ=1-ε. Based on the cross-entropy loss function with label smoothing, an output difference between positive and negative samples may be suppressed, so that the recall model has a stronger generalization capability.

Label smoothing is a regularization technology, which is used to alleviate overfitting. In the cross-entropy loss function with label smoothing, smoothing processing is performed on probability distribution of a true label, so that a model does not predict a class with excessive confidence during training, and a risk of overfitting is reduced. Specifically, the cross-entropy loss function with label smoothing may be considered as changing the probability distribution of the true label from a one-hot vector to smooth probability distribution. The smooth probability distribution enables the recall model to pay more attention to data distribution during training, rather than paying excessive attention to a specific class. In this way, the model can be more robust, and the risk of overfitting is reduced. In addition, the cross-entropy loss function with label smoothing may also implement regularization to a certain extent. In the cross-entropy loss function with label smoothing, the smooth probability distribution makes the model smoother during training, thereby reducing complexity of the model and further reducing the risk of overfitting.

Operation 840: Reversely adjust, based on the second loss, weight parameters of some network layers in the recall model after pre-training.

In some embodiments, the weight parameters of some network layers in the recall model may be adjusted in the gradient descent method based on the second loss, to minimize the second loss function. In some embodiments, in operation 840, only weight parameters of the decoder network in the recall model may be adjusted, or weight parameters of an output layer and a set number of network layers before the output layer in the decoder network are adjusted. In this way, a parameter adjustment amount can be reduced, and training time of the recall model can be reduced.

For each second sample pair, fine tune training is iteratively performed on the recall model based on the process shown in operation 810 to operation 840, until the fine tune training end condition is met. After the fine tune training ends, the recall model may be used for online application, to accurately recall corresponding related multimedia for multimedia based on a resource identifier of the multimedia.

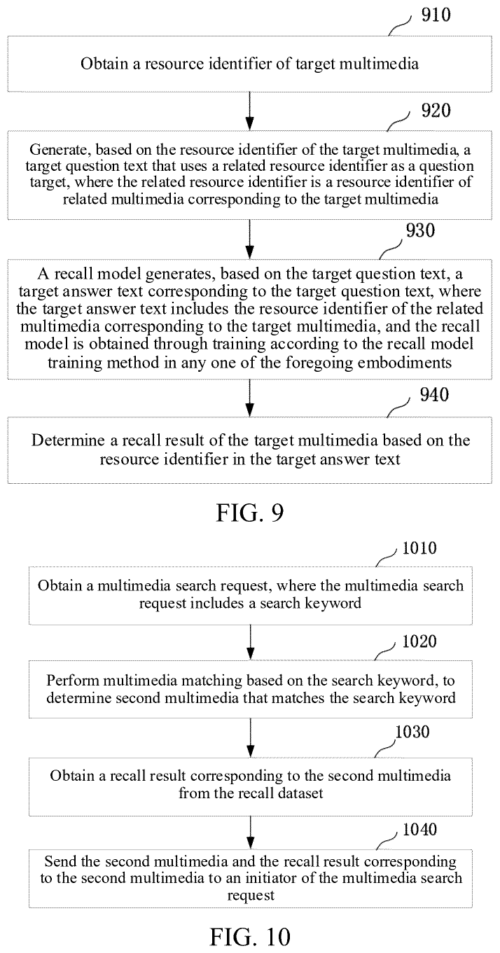

FIG. 9 is a flowchart of a recall method according to an embodiment of the present disclosure. The recall method may be performed by an electronic device such as a server. As shown in FIG. 9, the recall method includes the following operation 910 to operation 940. Detailed descriptions are as follows:

Operation 910: Obtain a resource identifier of target multimedia.

The target multimedia refers to multimedia whose recall result is to be determined. In some embodiments, each multimedia in a multimedia library may be respectively used as target multimedia, to determine a recall result corresponding to each multimedia in the multimedia library according to the method of the present disclosure.

Operation 920: Generate, based on the resource identifier of the target multimedia, a target question text that uses a related resource identifier as a question target. The related resource identifier is a resource identifier of related multimedia corresponding to the target multimedia.

In some embodiments, the target question text may be generated based on a second question template and the resource identifier of the target multimedia. Specifically, the resource identifier of the target multimedia is filled into a position in the second question template that represents a resource identifier of multimedia used as reference, to obtain the target question text. A form of the second question template may be as described above, and details are not described herein again.

Operation 930: A recall model generates, based on the target question text, a target answer text corresponding to the target question text. The target answer text includes the resource identifier of the related multimedia corresponding to the target multimedia. The recall model is obtained through training according to the recall model training method in any one of the foregoing embodiments.

In operation 930, the target question text is inputted into an encoder network of the recall model. The encoder network performs semantic encoding on the target question text, to obtain a semantic encoding sequence corresponding to the target question text. Then, a decoder network of the recall model performs decoding on the semantic encoding sequence corresponding to the target question text, to obtain the target answer text.

Operation 940: A recall result of the target multimedia is determined based on the resource identifier in the target answer text.

Based on a corresponding relationship between the multimedia and the resource identifier, the multimedia corresponding to the resource identifier in the target answer text can be correspondingly determined. The multimedia corresponding to the resource identifier in the target answer text is the related multimedia corresponding to the target multimedia. In operation 940, the related multimedia corresponding to the target multimedia and determined based on the resource identifier in the target answer text is correspondingly used as the recall result of the target multimedia.

In the present disclosure, a recall task for multimedia is converted into a text generation task, that is, for target multimedia to be recalled, a target question text that uses a related resource identifier as a question target is generated based on a resource identifier of the target multimedia. Then, a trained recall model is called to generate, based on the target question text, a target answer text for the target question text. As the target question text uses the related resource identifier as the question target, the target answer text generated by the trained recall model includes the resource identifier corresponding to the related multimedia corresponding to the target multimedia. In this way, the related multimedia corresponding to the target multimedia can be correspondingly determined based on the resource identifier corresponding to the related multimedia corresponding to the target multimedia, to recall the related multimedia corresponding to the target multimedia.

As the recall model is obtained through performing pre-training on a plurality of first text pairs and performing fine tune training on a plurality of second text pairs, the recall model accurately learns an association relationship between a resource identifier and description information of multimedia, to use a feature of the description information of the multimedia as feature representation of the resource identifier. In this way, when the recall model is used for multimedia recall, multimedia highly relevant to the feature representation of the resource identifier (that is, to the feature of the description information of the multimedia) can be recalled based on the learned association relationship between the resource identifier and the description information of the multimedia. Therefore, a correlation between recalled multimedia and the target multimedia used as reference can be ensured, to improve multimedia recall accuracy.

In some embodiments, after operation 940, the method further includes: associatively storing the resource identifier of the target multimedia and the recall result of the target multimedia in a recall dataset.

In some embodiments, as shown in FIG. 10, the method includes the following operations:

Operation 1010: Obtain a multimedia search request. The multimedia search request includes a search keyword.

The search keyword may be a word used for limiting multimedia to be searched, for example, words that limit a leading actor, a multimedia name, a director, a scriptwriter, a type, and the like.

Operation 1020: Perform multimedia matching based on the search keyword, to determine second multimedia that matches the search keyword.

In some embodiments, the multimedia matching may be performed based on a maintained multimedia data table. The multimedia data table includes at least a value of multimedia under each description field, that is, the multimedia data table includes description information of each multimedia. Based on this, the search keyword may be matched with the description information of the multimedia in the multimedia data table, to determine multimedia that matches the search keyword, that is, the second multimedia. A quantity of the second multimedia determined by search keyword matching in a multimedia search request may be one or multiple.

Operation 1030: Obtain a recall result corresponding to the second multimedia from the recall dataset.

Recall results corresponding to a plurality of multimedia are stored in the recall dataset. Therefore, based on determining first multimedia, a recall result corresponding to the first multimedia may be obtained from the recall dataset based on a resource identifier of the first multimedia.

In some embodiments, the foregoing operation 910 to operation 940 and the process of storing the recall result of the multimedia into the recall dataset may be performed in an offline state. In this way, in a process of providing a recall search service online, the recall model does not need to be called to determine the recall result of the second multimedia only when the second multimedia is determined, but the recall model is called in advance in the offline state to determine a recall result of each multimedia and store the recall result. In this way, in the process of providing the recall search service online, the recall result of the multimedia can be directly read from the recall dataset, and thus, online service efficiency of the recall search service is improved, and response time is shortened.

In some other embodiments, if computing power of a server is sufficient to satisfy a response time requirement, when the second multimedia is determined through matching, the second multimedia may be used as the target multimedia, and then the recall result of the second multimedia is determined according to the process of operation 920 to operation 940.

Operation 1040: Send the second multimedia and the recall result corresponding to the second multimedia to an initiator of the multimedia search request.

Based on the embodiment corresponding to FIG. 10, by initiating a multimedia search request, the second multimedia matched based on the search keyword is returned to the initiator of the multimedia search request, and the related multimedia corresponding to the second multimedia is also returned. In this way, this can avoid a case in which a multimedia search request is initiated again when a user needs to search for multimedia that is similar to the second multimedia or that is of a same type as the second multimedia. Therefore, a number of interaction times between a terminal and the server is reduced, and user experience is improved.

In some embodiments, a user may be prompted in advance whether the related multimedia corresponding to the second multimedia to be searched needs to be added to a search result in a multimedia search scenario. When permission or consent of the user is obtained, based on the embodiment corresponding to FIG. 10, when a multimedia search is performed, the second multimedia and the recall result corresponding to the second multimedia are sent to the initiator of the multimedia search request. If the user does not agree to add, to the search result, the related multimedia corresponding to the second multimedia to be searched, the second multimedia that is determined by matching is sent to the initiator of the multimedia search request without sending the recall result of the second multimedia.

The following describes apparatus embodiments of the present disclosure, which may be used for performing the method in the foregoing embodiments of the present disclosure. For details not disclosed in the apparatus embodiments of the present disclosure, refer to the foregoing method embodiments of the present disclosure.

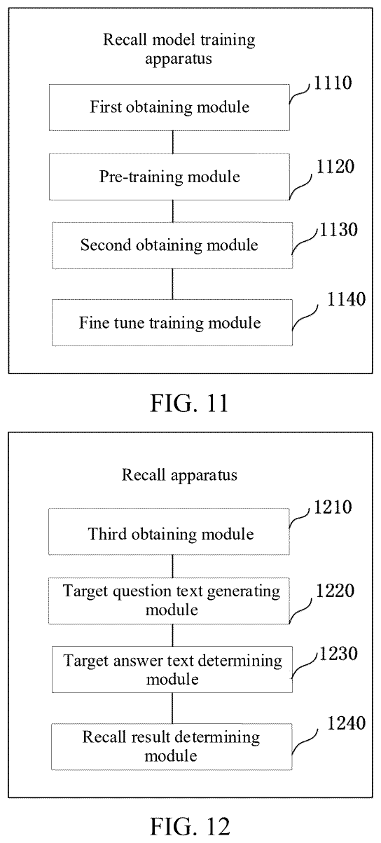

FIG. 11 is a block diagram of a recall model training apparatus according to an embodiment of the present disclosure. The recall model training apparatus may be configured in an electronic device, and is used to implement the recall model training method provided in the present disclosure. As shown in FIG. 11, the recall model training apparatus includes: a first obtaining module 1110, configured to obtain a plurality of first text pairs, where the first text pair includes a first question text and a first answer text, the first question text is a text generated based on description information of multimedia that uses a resource identifier of the multimedia as a question target, and the first answer text is a resource identifier targeted by a question of the first question text; a pre-training module 1120, configured to pre-train a recall model based on first question texts and first answer texts in the plurality of first text pairs; a second obtaining module 1130, configured to obtain a plurality of second text pairs, where the second text pair includes a second question text and a second answer text, the second question text is a text that uses a resource identifier of related multimedia as a question target, the second answer text is a resource identifier of the related multimedia that is targeted by a question of the second question text, and the related multimedia involved in the second text pair corresponds to the multimedia involved in the first text pair; and a fine tune training module 1140, configured to perform fine tune training on the pre-trained recall model based on second question texts and second answer texts in the plurality of second text pairs.

In some embodiments, the recall model includes an encoder network and a decoder network. The pre-training module 1120 includes: a first semantic encoding unit, configured to perform, by the encoder network, semantic encoding on the first question text, to obtain a first semantic encoding sequence corresponding to the first question text; a first decoding unit, configured to perform, by the a decoder network, decoding on the first semantic encoding sequence, to obtain a predicted answer text corresponding to the first question text; a first loss determining unit, configured to calculate a first loss based on the predicted answer text corresponding to the first question text and the corresponding first answer text; and a first adjustment unit, configured to reversely adjust weight parameters of the encoder network and the decoder network based on the first loss.

In some embodiments, the fine tune training module 1140 includes: a second semantic encoding unit, configured to perform, by the pre-trained encoder network, semantic encoding on the second question text, to obtain a second semantic encoding sequence corresponding to the second question text; a second decoding unit, configured to perform, by the pre-trained decoder network, decoding on the second semantic coding sequence, to obtain a predicted answer text corresponding to the second question text; a second loss determining unit, configured to calculate a second loss based on the predicted answer text corresponding to the second question text and the corresponding second answer text; and a second adjustment unit, configured to reversely adjust weight parameters of some network layers in the pre-trained recall model based on the second loss.

In some embodiments, the recall model training apparatus further includes: a fourth obtaining module, configured to obtain the description information of the multimedia and the resource identifier corresponding to the multimedia; a first question text determining module, configured to generate, based on a value of at least one description field in the description information, the first question text that uses the resource identifier of the multimedia as the question target; and a first answer text determining module, configured to use the resource identifier of the multimedia as the first answer text corresponding to the first question text.

In some embodiments, the first question text determining module includes: a first question template obtaining unit, configured to obtain a first question template, where the first question template uses the resource identifier as a question target, and the first question template indicates at least one description field; a first obtaining unit, configured to obtain, from the description information of the multimedia, a value of each description field indicated by the first question template; and a first combination unit, configured to combine the obtained value of the description field with the first question template, to obtain the first question text.

In some embodiments, the recall model training apparatus further includes: a second obtaining unit, configured to obtain multimedia feedback data, where the multimedia feedback data indicates at least two multimedia for which a feedback operation is triggered within set duration; a second question text determining unit, configured to generate, based on a resource identifier corresponding to first multimedia in the at least two multimedia, a second question text that uses a resource identifier of related multimedia corresponding to the first multimedia as a question target, and the related multimedia corresponding to the first multimedia includes at least one multimedia other than the first multimedia in the at least two multimedia; and a second answer text determining unit, configured to use the resource identifier of the related multimedia corresponding to the first multimedia as the second answer text corresponding to the second question text.

In some embodiments, the second question text determining unit includes: a second question template obtaining unit, configured to obtain a second question template, where the second question template uses the resource identifier of the related multimedia as a question target; a second combination unit, configured to combine the resource identifier corresponding to the first multimedia in the at least two multimedia with the second question template, to obtain the second question text.

FIG. 12 is a block diagram of a recall apparatus according to an embodiment of the present disclosure. The recall apparatus may be configured in an electronic device, and is used to implement the recall method provided in the present disclosure. As shown in FIG. 12, the recall apparatus includes a third obtaining module 1210, a target question text generation module 1220, a target answer text determining module 1230, and a recall result determining module 1240. The third obtaining module 1210 is configured to obtain a resource identifier of target multimedia. The target question text generation module 1220 is configured to generate, based on the resource identifier of the target multimedia, a target question text that uses a related resource identifier as a question target, and the related resource identifier is a resource identifier of related multimedia corresponding to the target multimedia. The target answer text determining module 1230 is configured to generate, by a recall model, based on the target question text, a target answer text corresponding to the target question text. The target answer text includes the resource identifier of the related multimedia corresponding to the target multimedia. The recall model is obtained through training based on the recall model training method in any one of the foregoing embodiments. The recall result determining module 1240 is configured to determine a recall result of the target multimedia based on the resource identifier in the target answer text.

In some embodiments, the recall apparatus further includes an association storage module, configured to associatively store the resource identifier of the target multimedia and the recall result of the target multimedia in a recall dataset.

In some embodiments, the recall apparatus further includes: a fifth obtaining module, configured to obtain a multimedia search request, where the multimedia search request includes a search keyword; a matching module, configured to perform multimedia matching based on the search keyword, to determine second multimedia that matches the search keyword; a recall result obtaining module, configured to obtain a recall result corresponding to the second multimedia from the recall dataset; and a sending module, configured to send the second multimedia and the recall result corresponding to the second multimedia to an initiator of the multimedia search request.

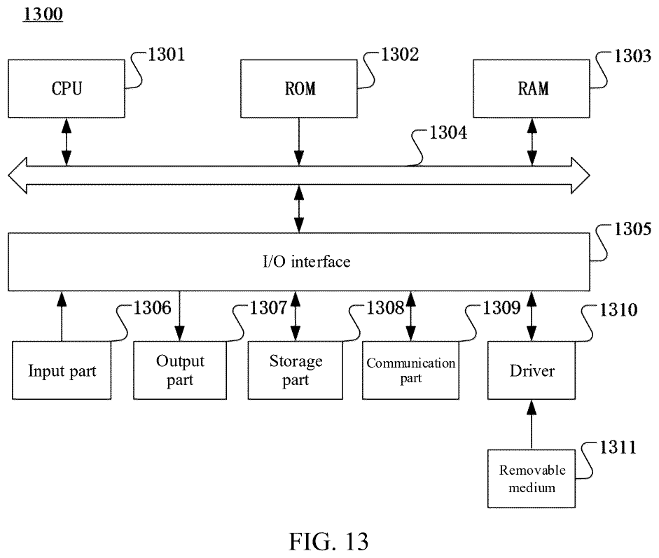

FIG. 13 is a schematic diagram of a structure of a computer system adapted to implement an electronic device according to an embodiment of the present disclosure. A computer system 1300 of the electronic device shown in FIG. 13 is merely an example, and does not constitute any limitation on functions and use ranges of the embodiments of the present disclosure. The electronic device may be configured to perform the recall model training method provided in the present disclosure, or may be configured to perform the recall method provided in the present disclosure.

As shown in FIG. 13, the computer system 1300 includes a central processing unit (CPU) 1301, which may perform various suitable actions and processing based on a program stored in a read-only memory (ROM) 1302 or a program loaded from a storage part 1308 into a random access memory (RAM) 1303, for example, perform the method in the foregoing embodiments. The RAM 1303 further stores various programs and data required for system operations. The CPU 1301, the ROM 1302, and the RAM 1303 are connected to each other by using a bus 1304. An input/output (I/O) interface 1305 is also connected to the bus 1304.

The following components are connected to the I/O interface 1305: an input part 1306, including a keyboard, a mouse, or the like; an output part 1307, including a cathode ray tube (CRT), a liquid crystal display (LCD), a speaker, or the like; the storage part 1308, including a hard disk, or the like; and a communication part 1309, including a network interface card such as a local area network (LAN) card or a modem. The communication part 1309 performs communication processing by using a network such as the Internet. A driver 1310 is also connected to the I/O interface 1305 as required. A removable medium 1311 such as a magnetic disk, an optical disc, a magneto-optical disk, or a semiconductor memory is mounted on the driver 1310 as required, so that a computer program read from the removable medium 1311 is installed into the storage part 1308 as required.

Particularly, according to an embodiment of the present disclosure, the processes described in the foregoing by referring to the flowcharts may be implemented as computer software programs. For example, this embodiment of the present disclosure includes a computer program product, which includes a computer program carried on a computer-readable medium, and the computer program includes program code used for performing the methods shown in the flowcharts. In such an embodiment, by using the communication part 1309, the computer program may be downloaded and installed from a network, and/or installed from the removable medium 1311. When the computer program is executed by the CPU 1301, the various functions limited in the system of the present disclosure are executed.

The computer-readable medium shown in the embodiments of the present disclosure may be a computer-readable signal medium or a computer-readable storage medium or any combination of the two. The computer-readable storage medium may be, for example, but is not limited to, an electric, magnetic, optical, electromagnetic, infrared, or semi-conductive system, apparatus, or component, or any combination of the above. A more specific example of the computer-readable storage medium may include but is not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any appropriate combination thereof. In the present disclosure, the computer-readable storage medium may be any tangible medium containing or storing a program, and the program may be used by or used in combination with an instruction execution system, an apparatus, or a device. In the present disclosure, a computer-readable signal medium may include a data signal being in a baseband or propagated as a part of a carrier wave, the data signal carrying computer-readable program code. A data signal propagated in such a way may assume a plurality of forms, including, but not limited to, an electromagnetic signal, an optical signal, or any appropriate combination thereof. The computer-readable signal medium may further be any computer-readable medium in addition to a computer-readable storage medium. The computer-readable medium may send, propagate, or transmit a program that is used by or used in conjunction with an instruction execution system, an apparatus, or a device. The program code included in the computer-readable medium may be transmitted by using any suitable medium, including but not limited to: a wireless medium, a wire, or the like, or any suitable combination thereof.

The flowcharts and block diagrams in the accompanying drawings illustrate suitable system architectures, functions and operations that may be implemented by a system, a method, and a computer program product according to various embodiments of the present disclosure. Each box in a flowchart or a block diagram may represent a module, a program segment, or a part of code. The module, the program segment, or the part of code includes one or more executable instructions used for implementing specified logic functions. In some implementations used as substitutes, functions annotated in boxes may alternatively occur in a sequence different from that annotated in an accompanying drawing. For example, actually two boxes shown in succession may be performed basically in parallel, and sometimes the two boxes may be performed in a reverse sequence. This is determined by a related function. In addition, each box in a block diagram or a flowchart and a combination of boxes in the block diagram or the flowchart may be implemented by using a dedicated hardware-based system configured to perform a specified function or operation, or may be implemented by using a combination of dedicated hardware and a computer instruction.

A related unit described in the embodiments of the present disclosure may be implemented in a software manner, or may be implemented in a hardware manner, and the unit described can also be set in a processor. Names of these units do not constitute a limitation on the units in a case.

According to another aspect, the present disclosure further provides a computer-readable storage medium. The computer-readable medium may be included in the electronic device described in the foregoing embodiments, or may exist alone and is not disposed in the electronic device. The computer-readable medium carries a computer program. When a computer-readable storage instruction is implemented by the processor, the recall model training method or the recall method in any one of the foregoing embodiments is implemented.

According to an aspect of the embodiments of the present disclosure, a computer program product is provided. The computer program product includes a computer program, and the computer program is stored in a computer-readable storage medium. A processor of a computer device reads the computer program from the computer-readable storage medium, and executes the computer program, so that the computer device performs the recall model training method or the recall method in any one of the foregoing embodiments.

Although a plurality of modules or units of a device configured to perform actions are discussed in the foregoing detailed description, such division is not mandatory. Actually, according to the implementations of the present disclosure, the features and functions of two or more modules or units described above may be specifically implemented in one module or unit. On the contrary, the features and functions of one module or unit described above may be further divided to be embodied by a plurality of modules or units.

According to the foregoing descriptions of the implementations, a person skilled in the art may readily understand that the exemplary implementations described herein may be implemented by using software, or may be implemented by combining software and necessary hardware. Therefore, the technical solutions of the embodiments of the present disclosure may be implemented in a form of a software product. The software product may be stored in a non-volatile storage medium (which may be a CD-ROM, a USB flash drive, a removable hard disk, or the like) or on the network, including several instructions for instructing a computing device (which may be a personal computer, a server, a touch terminal, a network device, or the like) to perform the methods according to the embodiments of the present disclosure.

In the present disclosure, a recall model is first pre-trained based on a plurality of first text pairs. As a first question text in the first text pair is generated based on description information of multimedia, the first question text uses a resource identifier of the multimedia as a question target, and a first answer text is the resource identifier of the multimedia, through pre-training, the recall model can learn an association relationship between the resource identifier of the multimedia and the description information of the multimedia, to determine feature representation of the resource identifier of the multimedia based on a feature of the description information of the multimedia. After the pre-training ends, fine tune training is performed on the pre-trained recall model based on a second question text that uses a resource identifier of related multimedia corresponding to the multimedia as a question target, and based on a second answer text that includes the resource identifier of the related multimedia corresponding to the multimedia. In this way, the recall model can use the association relationship between the resource identifier of the multimedia and the description information of the multimedia that the recall model learned in the pre-training stage, to learn, based on the resource identifier of the multimedia and the resource identifier of the related multimedia corresponding to the multimedia in the fine tune training stage, feature commonality between multimedia used as reference and the related multimedia corresponding to the multimedia. Therefore, in a subsequent application process, the recall model can accurately predict, based on the resource identifier of the multimedia used as the reference, the resource identifier of the related multimedia corresponding to the multimedia, to accurately recall the related multimedia corresponding to the multimedia, and effectively ensure a correlation between the recalled related multimedia and the multimedia used as the reference. In addition, according to the solution of the present disclosure, a multimedia recall task is converted into a text generation task.

After considering the specification and practicing the implementations of the present disclosure, a person skilled in the art may easily conceive of other implementations of the present disclosure. The present disclosure is intended to cover any variation, use, or adaptive change of the present disclosure. These variations, uses, or adaptive changes follow the general principles of the present disclosure and include common general knowledge or common technical means in the art that are not disclosed in the present disclosure.

The present disclosure is not limited to the precise structures described above and shown in the accompanying drawings, and various modifications and changes can be made without departing from the scope of the present disclosure. The scope of the present disclosure is limited only by the appended claims.

What is claimed is:

1. A method for recall model training, performed by an electronic device, and the method comprising:
obtaining a plurality of first text pairs, a first text pair of the plurality of first text pairs comprising a first question text and a first answer text, the first question text being a text generated based on description information of multimedia and using a resource identifier of the multimedia as a question target, and the first answer text being a resource identifier targeted by a question of the first question text;
pre-training a recall model based on first question texts and first answer texts in the plurality of first text pairs;
obtaining a plurality of second text pairs, the second text pair of the plurality of second text pairs comprising a second question text and a second answer text, the second question text being a text that uses a resource identifier of related multimedia as a question target, the second answer text being a resource identifier of the related multimedia targeted by a question of the second question text, and the related multimedia involved in the second text pair corresponding to the multimedia involved in the first text pair; and
performing fine tune training on the pre-trained recall model based on second question texts and second answer texts in the plurality of second text pairs.

2. The method according to claim 1, wherein the recall model comprises an encoder network and a decoder network; and pre-training the recall model based on the first question texts and the first answer texts in the plurality of first text pairs comprises:
performing, by the encoder network, semantic encoding on the first question text, to obtain a first semantic encoding sequence corresponding to the first question text;
decoding, by the decoder network, the first semantic encoding sequence, to obtain a predicted answer text corresponding to the first question text;
calculating a first loss based on the predicted answer text corresponding to the first question text and the corresponding first answer text; and
reversely adjusting weight parameters of the encoder network and the decoder network based on the first loss.

3. The method according to claim 2, wherein performing the fine tune training on the pre-trained recall model based on the second question texts and the second answer texts in the plurality of second text pairs comprises:
performing, by a pre-trained encoder network, semantic encoding on the second question text, to obtain a second semantic encoding sequence corresponding to the second question text;
decoding, by a pre-trained decoder network, the second semantic encoding sequence, to obtain a predicted answer text corresponding to the second question text;
calculating a second loss based on the predicted answer text corresponding to the second question text and the corresponding second answer text; and
reversely adjusting weight parameters of a number of network layers in the pre-trained recall model based on the second loss.

4. The method according to claim 1, further comprising:
obtaining the description information of the multimedia and the resource identifier corresponding to the multimedia;
generating, based on a value of at least one description field in the description information, a first question text that uses the resource identifier of the multimedia as the question target; and
using the resource identifier of the multimedia as the first answer text corresponding to the first question text.

5. The method according to claim 4, wherein generating, based on the value of the at least one description field in the description information, the first question text that uses the resource identifier of the multimedia as the question target comprises:
obtaining a first question template, the first question template using the resource identifier as the question target, and the first question template indicating the at least one description field;
obtaining, from the description information of the multimedia, a value of a description field indicated by the first question template; and
combining the obtained value of the description field with the first question template, to obtain the first question text.

6. The method according to claim 1, further comprising:
obtaining multimedia feedback data, the multimedia feedback data indicating at least two multimedia for which a feedback operation is triggered within a set duration;
generating, based on a resource identifier corresponding to first multimedia in the at least two multimedia, a second question text that uses a resource identifier of related multimedia corresponding to the first multimedia as a question target; the related multimedia corresponding to the first multimedia comprising at least one multimedia other than the first multimedia in the at least two multimedia; and
using the resource identifier of the related multimedia corresponding to the first multimedia as a second answer text corresponding to the second question text.

7. The method according to claim 6, wherein generating, based on the resource identifier corresponding to the first multimedia in the at least two multimedia, the second question text that uses the resource identifier of the related multimedia corresponding to the first multimedia as the question target comprises:
obtaining a second question template, the second question template using the resource identifier of the related multimedia as the question target; and
combining the resource identifier corresponding to the first multimedia in the at least two multimedia with the second question template, to obtain the second question text.

8. An electronic device comprising one or more processors and a memory containing a computer program that, when being executed, causes the one or more processors to perform:
obtaining a plurality of first text pairs, a first text pair of the plurality of first text pairs comprising a first question text and a first answer text, the first question text being a text generated based on description information of multimedia and using a resource identifier of the multimedia as a question target, and the first answer text being a resource identifier targeted by a question of the first question text;
pre-training a recall model based on first question texts and first answer texts in the plurality of first text pairs;
obtaining a plurality of second text pairs, the second text pair of the plurality of second text pairs comprising a second question text and a second answer text, the second question text being a text that uses a resource identifier of related multimedia as a question target, the second answer text being a resource identifier of the related multimedia targeted by a question of the second question text, and the related multimedia involved in the second text pair corresponding to the multimedia involved in the first text pair; and
performing fine tune training on the pre-trained recall model based on second question texts and second answer texts in the plurality of second text pairs.

9. The device according to claim 8, wherein the one or more processors are further configured to perform:
performing semantic encoding on the first question text, to obtain a first semantic encoding sequence corresponding to the first question text;
decoding the first semantic encoding sequence, to obtain a predicted answer text corresponding to the first question text;
calculating a first loss based on the predicted answer text corresponding to the first question text and the corresponding first answer text; and
reversely adjusting weight parameters of the encoder network and the decoder network based on the first loss.

10. The device according to claim 9, wherein the one or more processors are further configured to perform:
performing semantic encoding on the second question text, to obtain a second semantic encoding sequence corresponding to the second question text;
decoding the second semantic encoding sequence, to obtain a predicted answer text corresponding to the second question text;
calculating a second loss based on the predicted answer text corresponding to the second question text and the corresponding second answer text; and
reversely adjusting weight parameters of a number of network layers in the pre-trained recall model based on the second loss.

11. The device according to claim 8, wherein the one or more processors are further configured to perform:
obtaining the description information of the multimedia and the resource identifier corresponding to the multimedia;
generating, based on a value of at least one description field in the description information, a first question text that uses the resource identifier of the multimedia as the question target; and
using the resource identifier of the multimedia as the first answer text corresponding to the first question text.

12. The device according to claim 11, wherein the one or more processors are further configured to perform:
obtaining a first question template, the first question template using the resource identifier as the question target, and the first question template indicating the at least one description field;
obtaining, from the description information of the multimedia, a value of a description field indicated by the first question template; and
combining the obtained value of the description field with the first question template, to obtain the first question text.

13. The device according to claim 8, wherein the one or more processors are further configured to perform:
obtaining multimedia feedback data, the multimedia feedback data indicating at least two multimedia for which a feedback operation is triggered within a set duration;
generating, based on a resource identifier corresponding to first multimedia in the at least two multimedia, a second question text that uses a resource identifier of related multimedia corresponding to the first multimedia as a question target; the related multimedia corresponding to the first multimedia comprising at least one multimedia other than the first multimedia in the at least two multimedia; and
using the resource identifier of the related multimedia corresponding to the first multimedia as a second answer text corresponding to the second question text.

14. The device according to claim 13, wherein the one or more processors are further configured to perform:
obtaining a second question template, the second question template using the resource identifier of the related multimedia as the question target; and
combining the resource identifier corresponding to the first multimedia in the at least two multimedia with the second question template, to obtain the second question text.

15. A non-transitory computer-readable storage medium containing a computer program that, when being executed, causes at least one processor to perform:
obtaining a plurality of first text pairs, a first text pair of the plurality of first text pairs comprising a first question text and a first answer text, the first question text being a text generated based on description information of multimedia and using a resource identifier of the multimedia as a question target, and the first answer text being a resource identifier targeted by a question of the first question text;
pre-training a recall model based on first question texts and first answer texts in the plurality of first text pairs;
obtaining a plurality of second text pairs, the second text pair of the plurality of second text pairs comprising a second question text and a second answer text, the second question text being a text that uses a resource identifier of related multimedia as a question target, the second answer text being a resource identifier of the related multimedia targeted by a question of the second question text, and the related multimedia involved in the second text pair corresponding to the multimedia involved in the first text pair; and
performing fine tune training on the pre-trained recall model based on second question texts and second answer texts in the plurality of second text pairs.

16. The storage medium according to claim 15, wherein the at least one processor is further configured to perform:
performing semantic encoding on the first question text, to obtain a first semantic encoding sequence corresponding to the first question text;
decoding the first semantic encoding sequence, to obtain a predicted answer text corresponding to the first question text;
calculating a first loss based on the predicted answer text corresponding to the first question text and the corresponding first answer text; and
reversely adjusting weight parameters of the encoder network and the decoder network based on the first loss.

17. The storage medium according to claim 16, wherein the at least one processor is further configured to perform:
performing semantic encoding on the second question text, to obtain a second semantic encoding sequence corresponding to the second question text;
decoding the second semantic encoding sequence, to obtain a predicted answer text corresponding to the second question text;
calculating a second loss based on the predicted answer text corresponding to the second question text and the corresponding second answer text; and
reversely adjusting weight parameters of a number of network layers in the pre-trained recall model based on the second loss.

18. The storage medium according to claim 15, wherein the at least one processor is further configured to perform:
obtaining the description information of the multimedia and the resource identifier corresponding to the multimedia;
generating, based on a value of at least one description field in the description information, a first question text that uses the resource identifier of the multimedia as the question target; and
using the resource identifier of the multimedia as the first answer text corresponding to the first question text.

19. The storage medium according to claim 18, wherein the at least one processor is further configured to perform:
obtaining a first question template, the first question template using the resource identifier as the question target, and the first question template indicating the at least one description field;
obtaining, from the description information of the multimedia, a value of a description field indicated by the first question template; and
combining the obtained value of the description field with the first question template, to obtain the first question text.

20. The storage medium according to claim 15, wherein the at least one processor is further configured to perform:
obtaining multimedia feedback data, the multimedia feedback data indicating at least two multimedia for which a feedback operation is triggered within a set duration;
generating, based on a resource identifier corresponding to first multimedia in the at least two multimedia, a second question text that uses a resource identifier of related multimedia corresponding to the first multimedia as a question target; the related multimedia corresponding to the first multimedia comprising at least one multimedia other than the first multimedia in the at least two multimedia; and
using the resource identifier of the related multimedia corresponding to the first multimedia as a second answer text corresponding to the second question text.
